(19) United States
(12) Patent Application Publication
(10) Pub. No.: US 2006/0102245 A1
(43) Pub. Date: May 18, 2006

(54) PUMPLESS PRESSURE SPRAYER

(76) Inventor: Ronald W. Kaechle, Lake Station, IN (US)

Correspondence Address: HARTMAN & HARTMAN, P.C., 552 EAST 700 NORTH, VALPARAISO, IN, 46383, US

(21) Appl. No.: 10/906,207

(22) Filed: Feb. 9, 2005

Related U.S. Application Data
(60) Provisional application No. 60/522,883, filed on Nov. 17, 2004.

(51) Int. Cl. B65B 3/04; B67D 5/06; B05B 9/01

(52) U.S. Cl. 141/18; 222/183; 239/526

(57) ABSTRACT

A handheld pressure sprayer and method for operating the sprayer that eliminates the requirement for a hand-operated pump or a compressor. The sprayer includes a tank with an opening through which a liquid can be introduced into the tank, a spray wand and nozzle assembly fluidically connected to the tank for dispensing the liquid therefrom, a canister releasably secured to the tank and containing a gas under pressure, a fitting coupling the canister to the tank and adapted to allow the canister to be replaced with a second canister, and a device for selectively dispensing the gas from the canister through the fitting to the tank.

### CROSS REFERENCE TO RELATED APPLICATIONS

This application claims the benefit of U.S. Provisional Application No. 60/522,883, filed Nov. 17, 2004.

### BACKGROUND OF THE INVENTION

The present invention generally relates to pressure sprayers of the type used to dispense liquid fertilizers, insecticides, herbicides, etc.

The prior art discloses tanks configured to be pressurized with air from a compressor for the purpose of dispensing a liquid. For example, U.S. Pat. No. 2,090,334 to Paasche discloses a hand-held spraying device having a head that is attached to a container and includes a sleeve and cap housing through which the container can be charged with compressed air. The sleeve and cap housing can be a conventional tire valve and valve stem assembly. U.S. Pat. No. 4,228,933 to Elson discloses a fluid-dispensing apparatus having a head that includes a spray nozzle, a valve through which the apparatus is charged with compressed air, and a pressure relief valve. As with Paasche, Elson's valve can be a tire valve and valve stem assembly (“Schrader valve”). U.S. Pat. No. 4,269,356 to Rose discloses a portable sprayer that includes a tank, a compressor associated with the tank, and a battery for powering the compressor to continuously supply compressed air to the tank. U.S. Pat. No. 5,931,207 to Gianino discloses a portable home and garden sprayer that includes a compressed air power unit secured to a tank for directly and continuously supplying compressed air to the tank.

While none of the sprayer units disclosed by these patents requires a hand pump to dispense a liquid, each is limited by the requirement for a compressor to deliver a pressuring gas from a suitable source, so that the need for a hand pump mounted to the tank is eliminated. As a result, the sprayer units are either not easily portable or require returning to a compressor for recharging with the pressurized gas.

### BRIEF SUMMARY OF THE INVENTION

The present invention provides a handheld pressure sprayer adapted to eliminate the requirement for a hand-operated pump by incorporating a pressurized replaceable vessel.

According to a first aspect of the invention, the sprayer includes a tank having a shape that defines an internal cavity and an opening through which a liquid can be introduced into the internal cavity. An airtight cap closes the opening of the tank, and a spray wand and nozzle assembly is fluidically connected to the internal cavity of the tank for dispensing the liquid therefrom. A canister releasably secured to the tank contains a gas under pressure. A fitting couples the canister to the internal cavity of the tank and is adapted to allow the canister to be replaced with a second canister. Finally, the sprayer is equipped with a device for selectively dispensing the gas from the canister through the fitting to the internal cavity of the tank to pressurize the internal cavity with the gas, and a pressure relief valve to prevent over-pressurizing of the tank by the gas dispensed from the canister. According to the invention, the sprayer does not comprise or require a hand pump or a compressor.

According to another aspect of the invention, the sprayer makes possible a method of applying a liquid by releasably securing to the tank a canister containing a gas under pressure, coupling the canister to the internal cavity of the tank with a fitting adapted to allow the canister to be replaced with a second canister, and selectively dispensing the gas from the canister through the fitting to the internal cavity of the tank to pressurize the internal cavity with the gas. The internal cavity of the tank is pressurized without a hand pump, and the pressure relief valve prevents over-pressurizing of the tank by the gas dispensed from the canister.

In view of the above, the sprayer of this invention does not require a hand pump to dispense a liquid, and also does not require a compressor to deliver a pressuring gas. As such, the sprayer of this invention is easily portable or does not require returning to a compressor for recharging with a pressurized gas.

Other objects and advantages of this invention will be better appreciated from the following detailed description.

### BRIEF DESCRIPTION OF THE DRAWINGS

FIG. 1 shows a handheld pumpless pressure sprayer in accordance with a preferred embodiment of the invention.

### DESCRIPTION OF THE INVENTION

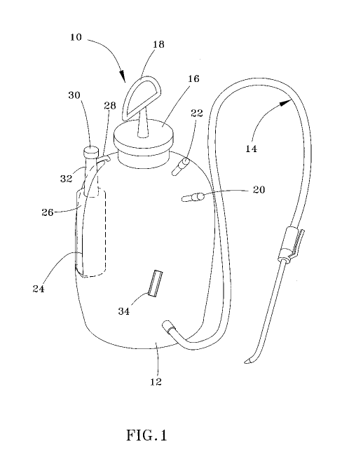

FIG. 1 shows a handheld sprayer 10 for use in the lawn and garden to apply a liquid such as a pesticide, herbicide, fertilizer, etc. The sprayer 10 comprises a tank 12 (e.g., plastic or metal) whose internal cavity is adapted for holding the liquid, and a spray wand and nozzle assembly 14 of any suitable type known in the art for directing a stream, spray, or mist of the liquid onto a surface or plant being treated. The tank 12 includes an airtight cap 16 equipped with a T-handle 18 by which the sprayer 10 can be held and transported. To the extent described thus far, the sprayer 10 is generally conventionally equipped.

According to a preferred aspect of the invention, the shape of the tank 12 is shown as defining an external cavity 24 sized to accommodate and secure a pressurized canister 26. The external cavity is generally defined by a recessed wall of the tank 12. The recessed wall surrounds and preferably grips the canister 26, and forms a shelf that supports the canister 26 from beneath. In this manner, the canister 26 can be carried on and with the tank 12 without encumbering the handling of the tank 12.

The canister 26 can be of a variety of types adapted to contain a pressurized gas, but is preferably of a commercially-available type used in air horns, such as a canister available from SeaSense. As such, the pressurized gas may be air but is preferably an aerosol propellant such as 1,1,1,2-tetrafluoroethane (CASRN 811-97-2). A valve 32 and fitting 28 couples the canister 26 to the tank 12. The valve 32 is preferably mounted to the canister 26 with a threaded connection that allows the canister 26 when spent to be replaced with a fully charged canister 26. A trigger or button 30 of the type conventionally provided on air horns permits the user to selectively pressurize the tank 12 with the contents of the canister 26. Due to the presence of the canister 26, the invention eliminates the need for a hand pump or compressor mounted to the tank 12.

FIG. 1 shows the tank 12 as being equipped with a clip 34 for securing the nozzle end of the wand and nozzle assembly 14. The tank 12 is also shown as optionally equipped with a fitting 20 (e.g., a tire air valve) through which the tank 12 can be charged with compressed air from an external source such as an air compressor (not shown), and a pressure relief valve 22 to prevent over-pressurizing of the tank 12.

To use the sprayer 10, the canister 26 is releasably secured to the tank 12, and the canister 26 is coupled with the fitting 28 to the internal cavity of the tank 12. Thereafter, by operating the button 30, the gas within the canister 26 can be selectively dispensed from the canister 26 through the fitting 28 to the internal cavity of the tank 12 to pressurize the internal cavity with the gas.

While the invention has been described in terms of a specific embodiment, it is apparent that other forms could be adopted by one skilled in the art. For example, the sprayer 10 could differ in appearance and construction from the embodiment shown in FIG. 1, and appropriate materials could be substituted for those noted. Therefore, the scope of the invention is to be limited only by the following claims.

What is claimed is:

1. A pumpless handheld sprayer for applying a liquid, the sprayer comprising:
a tank for holding the liquid, the tank having a shape that defines an internal cavity and an opening through which the liquid can be introduced into the internal cavity;
an airtight cap closing the opening of the tank;
a spray wand and nozzle assembly fluidically connected to the internal cavity of the tank for dispensing the liquid therefrom;
a canister releasably secured to the tank and containing a gas under pressure;
a fitting coupling the canister to the internal cavity of the tank, the fitting being adapted to allow the canister to be replaced with a second canister;
means for selectively dispensing the gas from the canister through the fitting to the internal cavity of the tank to pressurize the internal cavity with the gas; and
a pressure relief valve on the tank to prevent over-pressurizing of the tank by the gas dispensed from the canister;
wherein the sprayer does not comprise a hand pump or a compressor.

2. The pumpless handheld sprayer according to claim 1, wherein the airtight cap comprises a T-handle.

3. The pumpless handheld sprayer according to claim 1, further comprising a fitting on the tank through which the tank can be charged with a compressed gas from an external source other than the canister.

4. The pumpless handheld sprayer according to claim 1, wherein the shape of the tank defines an external cavity.

5. The pumpless handheld sprayer according to claim 4, wherein the canister is disposed within the external cavity of the tank.

6. The pumpless handheld sprayer according to claim 5, wherein the external cavity is defined by a recessed wall region of the tank.

7. The pumpless handheld sprayer according to claim 6, wherein the recessed wall region of the tank grips and supports the canister.

8. A method for applying a liquid with a handheld sprayer comprising a tank having a shape that defines an internal cavity and an opening through which the liquid can be introduced into the internal cavity, an airtight cap closing the opening of the tank, a spray wand and nozzle assembly fluidically connected to the internal cavity of the tank for dispensing the liquid therefrom, and a pressure relief valve, the method comprising:
releasably securing a canister to the tank, the canister containing a gas under pressure;
coupling the canister to the internal cavity of the tank with a fitting adapted to allow the canister to be replaced with a second canister; and
selectively dispensing the gas from the canister through the fitting to the internal cavity of the tank to pressurize the internal cavity with the gas;
wherein the pressure relief valve prevents over-pressurizing of the tank by the gas dispensed from the canister and the internal cavity of the tank is pressurized without a hand pump or a compressor.

9. The method according to claim 8, further comprising the step of shaping the tank to define an external cavity.

10. The method according to claim 9, wherein the step of releasably securing the canister results in the canister being disposed within the external cavity of the tank.

11. The method according to claim 10, wherein the tank is shaped so that the external cavity is defined by a recessed wall region of the tank.
